(19) United States
(12) Patent Application Publication
(10) Pub. No.: US 2022/0200807 A1
(43) Pub. Date: Jun. 23, 2022

(54) DEVICE ATTESTATION

(71) Applicant: NXP B.V., Eindhoven (NL)

(72) Inventors: Durgesh Pattamatta, Camas, WA (US); Miroslav Knezevic, Bee Cave, TX (US)

(21) Appl. No.: 17/125,725

(22) Filed: Dec. 17, 2020

(51) Int. Cl. H04L 9/32; H04L 9/06

(52) U.S. Cl. CPC H04L 9/3236; H04L 2209/38; H04L 9/0643; H04L 9/3247

(57) ABSTRACT

As may be implemented in accordance with one or more aspects of the disclosure, an apparatus and/or method involves generating, using hash circuitry, successive hash values corresponding to operational states of an apparatus using, for respective ones of the hash values, a previous one of the hash values and a current operational sate of the apparatus. The hash values may be written into a register. In response to an attestation request, one of the hash values may be retrieved from the register and signed using cryptographic circuitry. The signed hash value may be communicated to a remote circuit, therein providing attestation of an operational state of the apparatus.

### OVERVIEW

Aspects of various embodiments are directed to generating and implementing hash values for assessing operational states of an apparatus.

With the recent rise of Internet of Things, the number of always connected devices is rapidly growing. Security becomes an important issue given the increased interest in attacks on embedded devices and other apparatuses, as may come both from academia and industry. For instance, it can be challenging to ascertain whether a remote device has been compromised, such as by malware or other attacks. Under certain conditions, it can be difficult to ensure that operations of such devices are secure.

These and other matters have presented challenges to efficiencies of circuit implementations, for a variety of applications.

### SUMMARY

Various example embodiments are directed to issues such as those addressed above and/or others which may become apparent from the following disclosure concerning the operation of circuitry and related security. Such approaches may include ongoing runtime generation and utilization of cryptographic data for verification of an operational state of a particular device.

In certain example embodiments, aspects of the present disclosure involve iteratively generating hash values corresponding to current operational states of a device as the device carries out operations over time. Cryptographic circuitry then signs the hash values and provides the signed hash values as an indication of the operational state of the device and, in some instances, of cumulative characteristics of operational states as they very over time.

As may be implemented in accordance with one or more aspects of the disclosure, an apparatus and/or method involves generating, using hash circuitry, successive hash values corresponding to operational states of an apparatus using, for respective ones of the hash values, a previous one of the hash values and a current operational sate of the apparatus. The hash values may be written into a register. In response to an attestation request, one of the hash values may be retrieved from the register and signed using cryptographic circuitry. The signed hash value may be communicated to a remote circuit, therein providing attestation of an operational state of the apparatus.

As may be implemented in accordance with one or more aspects of the disclosure, an apparatus includes hash circuitry, cryptographic circuitry and control circuitry. The hash circuitry is configured to generate successive hash values corresponding to operational states of the apparatus using, for respective ones of the hash values, a previous one of the hash values and a current operational sate of the apparatus. The hash circuitry is further configured to write the hash values into a register. The cryptographic circuitry is configured to retrieve one of the hash values from the register and to sign the retrieved hash value, in response to an attestation request. The control circuitry is configured to cause the cryptographic circuitry to retrieve and sign the hash value from the register, and to communicate the signed hash value to a remote circuit, therein providing attestation of an operational state of the apparatus.

Another embodiment is directed to an apparatus including a runtime fingerprint register and hash circuitry coupled to the register and configured to successively generate hash values corresponding to operational states of the apparatus. Each successive hash value after a first hash value is generated using a previous one of the hash values and a current operational sate of the apparatus. The hash circuitry is also configured to write the successively-generated hash values into the register. The apparatus also includes cryptographic circuitry coupled to the register and configured to, in response to an attestation request for verifying a current operational state of the apparatus, retrieve and sign a most recent one of the successive hash values from the register. Control circuitry is configured and arranged with the cryptographic circuitry to communicate with a remote circuit for receiving the attestation request, control the cryptographic circuitry to retrieve and sign the hash value from the register, and communicate the signed hash value to the remote circuit. This may, for example, provide for attestation of an operational state of the apparatus. In some implementations, the hash circuitry is configured to generate the successive hash values in response to a software input corresponding to initiation of a software function, and the runtime fingerprint register is configured to restrict write access to write commands received directly from the hash circuitry.

The above discussion/summary is not intended to describe each embodiment or every implementation of the present disclosure. The figures and detailed description that follow also exemplify various embodiments.

### BRIEF DESCRIPTION OF FIGURES

Various example embodiments may be more completely understood in consideration of the following detailed description in connection with the accompanying drawings, in which:

FIG. 1 is a system-level diagram illustrating an example apparatus and approach, in accordance with the present disclosure; and

FIG. 2 is a flow chart illustrating an exemplary set of activities and/or data flow for a system, in accordance with the present disclosure.

While various embodiments discussed herein are amenable to modifications and alternative forms, aspects thereof have been shown by way of example in the drawings and will be described in detail. It should be understood, however, that the intention is not to limit the disclosure to the particular embodiments described. On the contrary, the intention is to cover all modifications, equivalents, and alternatives falling within the scope of the disclosure including aspects defined in the claims. In addition, the term “example” as used throughout this application is only by way of illustration, and not limitation.

### DETAILED DESCRIPTION

Aspects of the present disclosure are believed to be applicable to a variety of different types of apparatuses, systems and methods involving attestation of device operation. In certain implementations, aspects of the present disclosure have been shown to be beneficial when used in the context of insuring that a remote device (e.g., a computer or mobile device) is operating as expected, for instance has not been subjected to malware or other malicious operation, based on operating states of the remote device. Such states may involve, for example, hardware states, software states, or a combination thereof. In some embodiments, this approach may be carried out using existing circuitry along with a runtime fingerprint register that stores hash values that are generated using operating characteristics of the device, and a cryptographic circuit that signs the hash values and provides the signed hash values. This may be carried out in a manner that prevents access to the runtime fingerprint register, by processor running operations on the device. While not necessarily so limited, various aspects may be appreciated through the following discussion of non-limiting examples which use exemplary contexts.

Accordingly, in the following description various specific details are set forth to describe specific examples presented herein. It should be apparent to one skilled in the art, however, that one or more other examples and/or variations of these examples may be practiced without all the specific details given below. In other instances, well known features have not been described in detail so as not to obscure the description of the examples herein. For ease of illustration, the same reference numerals may be used in different diagrams to refer to the same elements or additional instances of the same element. Also, although aspects and features may in some cases be described in individual figures, it will be appreciated that features from one figure or embodiment can be combined with features of another figure or embodiment even though the combination is not explicitly shown or explicitly described as a combination.

Various aspects of the disclosure are directed to remote run-time device attestation utilizing a runtime fingerprint register to store hash values characterizing device operation, with communication of a signed version of the hash values to a remote party for use in attesting to an operational state of the device. This approach may use already available cryptographic accelerators (e.g., HASH and public-key crypto accelerators) on the device to compute the runtime fingerprint (RTF), providing negligible or otherwise low cost relative to overall device cost. The integrity of RTF is then used to attest to an authorized remote party that the device is in the expected state. This may, for example, be utilized to confirm that secure program flow has been executed as expected.

In some implementations, the RTF is computed as a cumulative measurement of the device run-time state. For instance, the following may be defined:

RTF(0)=HASH(FSBL)

RTF(i)=HASH(RTF(i−1)|sw_input),

where FSBL is the first-stage boot loader and sw_input is any subsequent input defined by a program that runs after FSBL has been completed. HASH is defined to be a cryptographically secure hash function, e.g. SHA-2 or SHA-3.

The physical register storing the RTF value may be configured such that it cannot be directly modified by software, for example by software operating on a CPU in the device in which attestation is carried out. This may be effected by ensuring the RTF register is not connected to any communication bus to which an application core of the device has access to. The RTF register may be further configured such that it may only be reset (to zero or an arbitrary constant) or written directly from the output of a dedicated HASH hardware accelerator. Since the HASH may involve a slow cryptographic operation, hardware acceleration may be used for improving the overall system performance. Once available, an existing HASH accelerator may be used for computing the RTF.

In some implementations, a public-key cryptographic (PKC) circuit existing in a device structure may be utilized for carrying out encryption as noted herein, and may also utilize a PKC hardware accelerator. For instance, the PKC circuit may sign hashed values before sending the signed hash values to an authorized remote party. Using this approach, the actual RTF value may be kept inaccessible to the host CPU, as only the RTF signature is communicated on a local bus. An authorized remote party may thus be able to compute the expected RTF and use it during RTF signature verification.

The PKC may sign the RTF value using a private key, and the private key may be selected by a remote party requesting attestation. The private key may be dedicated for purposes of signing the RTF value, isolated from the rest of the system and may be used such that it is not used for signing anything else (e.g., by the PKC accelerator). The remote party may thus own the corresponding public key used to verify the signature.

As may be implemented in accordance with one or more aspects of the disclosure, hash circuitry, cryptographic circuitry and control circuitry are utilized to provide attestation of operation of an apparatus, such as a computer or mobile device. The hash circuitry generates successive hash values corresponding to operational states of the apparatus using a previous hash value and a current operational sate of the apparatus. This may provide a cumulative indication of the state of the device as it operates over time. For instance, the successive hash values may be generated in response to a software input corresponding to initiation of a software function, such that a new hash value may be generated upon initiation of each new software input. This may, for example, provide verification that a series of software operations are carried out as intended.

The hash values may be written into a register where they are retrieved and signed by cryptographic circuitry in response to an attestation request. The control circuitry (e.g., a processor or CPU) may operate to cause the cryptographic circuitry to retrieve and sign the hash value from the register, and may facilitate communication of the signed hash value to a remote circuit. This may thus provide attestation of an operational state of the apparatus, to the remote circuit. Further, as this may be carried out without allowing the control circuitry to directly access the unsigned hash values, security of the information can be ensured.

The cryptographic circuitry may provide the signed hash value as an attestation of an operational state of the apparatus corresponding to initiation of a software program. Further, the cryptographic circuitry may prevent output of the hash values retrieved from the register that are not signed by cryptographic circuitry.

The apparatus may also include the register, which may be operable with the hash circuitry to restrict write access to those write commands received directly from the hash circuitry. As noted above, this may prevent access to the register by the control circuitry. In some implementations, the hash circuitry restricts the write access by preventing the control circuitry from writing data into the register. The register may restrict access to data stored therein by the cryptographic circuitry, by providing read access to the cryptographic circuitry and preventing write access by the cryptographic circuitry. The register may also restrict access for resetting data therein to reset commands received directly from the hash circuitry.

As may be implemented in accordance with one or more aspects of the disclosure, a method involves generating successive hash values corresponding to operational states of an apparatus using a previous hash value and current operational sate of the apparatus. Accordingly, each hash value may effectively characterize operational states characterized by all the previous hash values, cumulatively, and a current operational state of the apparatus. For instance, the successive hash values may be generated in response to a software input corresponding to initiation of a software function. The signed hash value may be provided as an attestation of an operational state of the apparatus corresponding to initiation of the software function therein.

The hash values may be written into a register. In response to an attestation request, one of the hash values may be retrieved from the register and signed using cryptographic circuitry. The signed hash value may be communicated to a remote circuit, therein providing attestation of an operational state of the apparatus. Output of hash values retrieved from the register that are not signed by cryptographic circuitry may be prevented.

Write access to the register may be restricted to write commands received directly from the hash circuitry. For instance, control circuitry such as a CPU may be restricted from writing data into the register. Read access may be provided to cryptographic circuitry, with write access by the cryptographic circuitry prevented. Reset access to data in the register may be restricted to reset commands received directly from the hash circuitry.

The hash values may be generated while the apparatus is executing programming instructions. The communicated (signed) hash value can be provided as attestation. For instance, when the signed hash value corresponds to a hash value for an expected operational state of the apparatus, further execution of programming instructions may be facilitated. If the signed hash value fails to correspond to a hash value for an expected operational state of the apparatus, execution of the programming instructions may be interrupted. Interrupting execution of the programming instructions may include generating an authentication request and, in response to receiving an authentication in response to the authentication request, facilitating further execution of the programming instructions.

Accordingly, a remote installer may require authentication by a user installing software on the apparatus. For instance, an installation procedure may be carried out for license transfer, such as starting an operating system, starting a program, and sending an attestation token. If the sequence is followed, the remote device will know what state the apparatus should be in. If the sequence is not followed, the remote device can detect deviation via the hash values. Various steps may then be taken, such as aborting installation and/or involving further attestation (e.g., by a user). For instance if another program is initiated by a user during an installation process, such acts may be verified as authentic, whereas malware initiation of a program may be detected as being malicious.

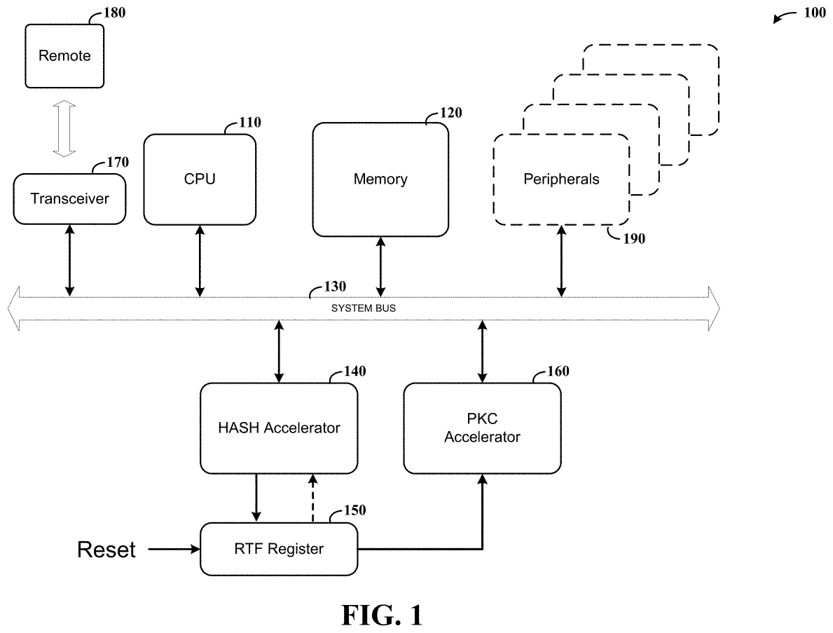

Turning now to the figures, FIG. 1 depicts an apparatus 100 for providing remote attestation, in accordance with one or more aspects of the disclosure. The apparatus includes a CPU 110, memory 120, and a system bus 130, as may be utilized to carry out device functions. The apparatus also includes a hash accelerator 140, runtime fingerprint (RTF) register 150, and a PKC accelerator 160. The apparatus 100 may also include a transceiver 170 for communicating with a remote device 180 (or a plurality of such devices), as well as peripherals 190.

The apparatus 100 may be implemented in a variety of manners. In some embodiments, the hash accelerator 140 generates hash values based upon an operational state of the apparatus, and stores the hash values in the RTF register 150. Hash values may be generated, for example, in response to a software or hardware input, such as the initiation of a program. These hash values may be updated over time, and may further be cumulative with each new hash value being generated using a previously-generated hash value (e.g., as may be obtained from the RTF register 150) along with a current operational state of the apparatus. The RTF register 150 may further limit write and reset access to accesses by the hash accelerator 140, which may be useful for preventing the CPU 110 and any undesirable operation thereof (e.g., via malware) from accessing hash values stored in the RTF register. Hash accelerator 140 may thus reset the RTF register 150 prior to writing a new hash value therein.

In some embodiments, the apparatus 100 is implemented as follows. The hash accelerator 140 operates to generate a hash value corresponding to operation of the apparatus, for example in response to initiation of a software or hardware event. This may involve utilizing the CPU 110 to instruct the hash accelerator 140 to generate the hash value at such a time, utilizing data communicated on the system bus 130 and storing the hash value in the RTF register 150. This process may be carried out iteratively as noted above, and may further use a previously-generated hash value as an input for generating a current hash value.

When an attestation request is received from a remote device 180 via transceiver 170, the CPU 110 may direct the PKC accelerator 160 to access a current hash value from the RTF register, sign the accessed hash value and transmit that signed hash value via the system bus 130. The signed hash value may then be transmitted to the remote device 180 via transceiver 170.

In some implementations, the PKC accelerator 160 signs a current value stored in the RTF register 150, appended with a cryptographic challenge issued by the remote device 180. A universally unique device identifier (UUID) may also be included to identify a source of the signed RTF, and the signature is returned to the remote device 180.

The remote device 180 may evaluate received hash values signed by the PKC accelerator in a variety of manners. For instance, the remote device 180 may verify the signed hash value using known characteristics of the encryption process carried out with hash accelerator 140 and PKC accelerator 160, to ascertain the state of the apparatus. For instance, the remote device 180 may use a public key to verify the signature, which is carried out using a private key. If the state corresponds to an expected state, attestation may be deemed successful. If the state does not correspond to the expected state, attestation may be deemed negative, or further steps for attestation may be carried out such as by requiring user interaction at the apparatus.

Certain embodiments are directed to an apparatus involving the register 150 and related programming instructions that may be implemented with a system already having the hash accelerator 140, PKC accelerator 160, CPU 110 and memory 120. As such, certain embodiments may be directed to a specially programmed CPU 110 for instructing the hash accelerator 140 to generate the hash value, and for instructing the PKC accelerator to sign and provide hash values from the RTF register.

In some embodiments, the hash values generated and stored in the RTF register 150 measure boot images during boot time, and may be used as a secure log compressor to track secure program flow. Signed hash values may thus provide assurance that program flow within the apparatus has reached the point of interest (e.g., server session establishment) by going through all function calls while no other unexpected calls have been made due to logical or physical attacks on the device. Certain embodiments are directed to measuring or otherwise characterizing program flow via accumulation into a hash digest in the RTF register 150. By relying on the cryptographic strength of the underlying HASH function, an authorized remote party may have access to a very strong assurance that the secure program flow has been executed as expected. The value store in the RTF register 150 may also accumulate the hardware state of the apparatus (e.g., system on chip), including but not limited to, test state, debug state, life-cycle state, temporal boot state, silicon manufacturer configuration, and customer configuration.

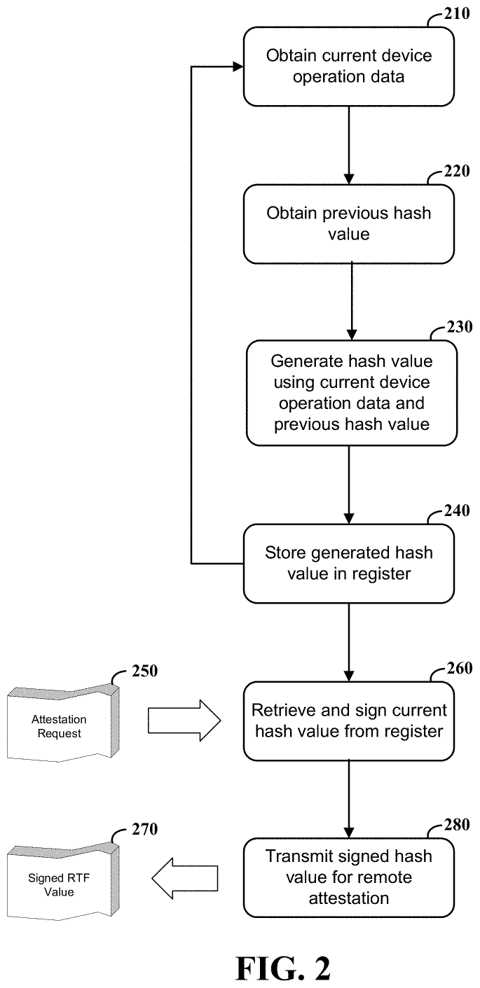

FIG. 2 is a flow chart illustrating an exemplary set of activities and/or data flow for a system, in accordance with the present disclosure. At blocks 210 and 220, current device operation data and a previous hash value are obtained, and this information is used to generate a hash value at block 230. The generated hash value is then stored in a register at block 240. The steps at blocks 210-240 may be repeated for providing successive hash values corresponding to operational states of an apparatus. Each hash value may effectively characterize cumulative operational states characterized by the previous hash values and a current operational state. As noted herein, the successive hash values may each be generated in response to a software input corresponding to initiation of a software function, for instance as may involve initiation of a program and/or a step in a program.

In response to receiving an attestation request 250, a current value from the register is retrieved and signed at block 260 using cryptographic circuitry. This may be carried out, for example, using signature information provided in the attestation request 250. The signed hash value 270 (e.g., an RTF value as characterized herein) may be transmitted at block 280, by transmitting the signed value from the register to a remote device initiating the attestation request 250. This value may thus provide attestation of an operational state of the apparatus corresponding to initiation of the software function therein.

As examples, the specification describes and/or illustrates aspects useful for implementing the claimed disclosure by way of various circuits or circuitry which may be illustrated as or using terms such as blocks, modules, device, system, unit, controller, CPU, accelerator, transceiver and/or other circuit-type depictions (e.g., reference numerals 110, 140, 160 and 170 of FIG. 1 may depict a block/module as described herein). Such circuits or circuitry may be used together with other elements to exemplify how certain embodiments may be carried out in the form or structures, steps, functions, operations, activities, etc. As examples, wherein such circuits or circuitry may correspond to logic circuitry (which may refer to or include a code-programmed/configured CPU), in one example the logic circuitry may carry out a process or method (sometimes “algorithm”) by performing hashing, signing and attestation functions.

In certain of the above-discussed embodiments, one or more modules are discrete logic circuits or programmable logic circuits configured and arranged for implementing these operations/activities, as may be carried out in the approaches shown in FIGS. 1 and 2. In certain embodiments, such a programmable circuit is one or more computer circuits, including memory circuitry for storing and accessing a program to be executed as a set (or sets) of instructions (and/or to be used as configuration data to define how the programmable circuit is to perform), and an algorithm or process as described with FIG. 2 is used by the programmable circuit to perform the related steps, functions, operations, activities, etc. Depending on the application, the instructions (and/or configuration data) can be configured for implementation in logic circuitry, with the instructions (whether characterized in the form of object code, firmware or software) stored in and accessible from a memory (circuit). As another example, where the specification may make reference to a “first [type of structure]”, a “second [type of structure]”, etc., where the [type of structure] might be replaced with terms such as [“circuit”, “circuitry” and others], the adjectives “first” and “second” are not used to connote any description of the structure or to provide any substantive meaning; rather, such adjectives are merely used for English-language antecedence to differentiate one such similarly-named structure from another similarly-named structure (e.g., “first circuit configured to convert . . . ” is interpreted as “circuit configured to convert . . . ”).

Based upon the above discussion and illustrations, those skilled in the art will readily recognize that various modifications and changes may be made to the various embodiments without strictly following the exemplary embodiments and applications illustrated and described herein. For example, methods as exemplified in the figures may involve steps carried out in various orders, with one or more aspects of the embodiments herein retained, or may involve fewer or more steps. Referring to FIG. 1 as an example, certain embodiments are directed to the RTF register 150 along with related programming implemented by the CPU 110 that causes hash circuitry and encryption (e.g., PKC) circuitry, on a device in which the RTF register is installed, to operate in accordance with one or more embodiments herein. Such modifications do not depart from the true spirit and scope of various aspects of the disclosure, including aspects set forth in the claims

What is claimed is:

1. An apparatus comprising:
hash circuitry to generate successive hash values corresponding to operational states of the apparatus using, for respective ones of the hash values, a previous one of the hash values and a current operational sate of the apparatus, and to write the hash values into a register;
cryptographic circuitry to retrieve one of the hash values from the register and to sign the retrieved hash value, in response to an attestation request; and
control circuitry to cause the cryptographic circuitry to retrieve and sign the hash value from the register, and to communicate the signed hash value to a remote circuit, therein providing attestation of an operational state of the apparatus.

2. The apparatus of claim 1, further including the register, the register being configured and arranged with the hash circuitry to restrict write access to write commands received directly from the hash circuitry.

3. The apparatus of claim 2, wherein the hash circuitry is configured to restrict the write access by preventing the control circuitry from writing data into the register.

4. The apparatus of claim 2, wherein the register is configured to restrict access to data stored therein by the cryptographic circuitry by providing read access to the cryptographic circuitry and preventing write access by the cryptographic circuitry.

5. The apparatus of claim 2, wherein the register is configured to restrict access for resetting data therein to reset commands received directly from the hash circuitry.

6. The apparatus of claim 1, wherein the hash circuitry is configured to generate the successive hash values in response to a software input corresponding to initiation of a software function.

7. The apparatus of claim 6, wherein the cryptographic circuitry is configured to provide the signed hash value as an attestation of an operational state of the apparatus corresponding to initiation of the software function.

8. The apparatus of claim 1, wherein the cryptographic circuitry is configured to prevent output of the hash values retrieved from the register that are not signed by cryptographic circuitry.

9. A method comprising:
generating, using hash circuitry, successive hash values corresponding to operational states of an apparatus using, for respective ones of the hash values, a previous one of the hash values and a current operational sate of the apparatus;
writing the hash values into a register;
in response to an attestation request, retrieving one of the hash values from the register and signing the retrieved hash value using cryptographic circuitry; and
communicating the signed hash value to a remote circuit, therein providing attestation of an operational state of the apparatus.

10. The method of claim 9, further including restricting write access to the register to write commands received directly from the hash circuitry.

11. The method of claim 10, wherein restricting the write access includes preventing control circuitry from writing data into the register.

12. The method of claim 10, wherein restricting the write access includes providing read access to the cryptographic circuitry and preventing write access by the cryptographic circuitry.

13. The method of claim 10, wherein restricting the write access includes restricting access for resetting data in the register to reset commands received directly from the hash circuitry.

14. The method of claim 9, wherein generating the successive hash values is carried out in response to a software input corresponding to initiation of a software function.

15. The method of claim 14, signing the retrieved has value includes providing the signed hash value as an attestation of an operational state of the apparatus corresponding to initiation of the software function therein.

16. The method of claim 9, further including preventing output of the hash values retrieved from the register that are not signed by cryptographic circuitry.

17. The method of claim 9, wherein generating the successive hash values includes generating the hash values while the apparatus is executing programming instructions, further including using the communicated signed hash value as attestation by:
in response to the signed hash value corresponding to a hash value for an expected operational state of the apparatus, facilitating further execution of the programming instructions; and
in response to the signed hash value failing to correspond to a hash value for an expected operational state of the apparatus, interrupting execution of the programming instructions.

18. The method of claim 17, wherein interrupting the execution of the programming instructions includes generating an authentication request and, in response to receiving an authentication in response to the authentication request, facilitating further execution of the programming instructions.

19. An apparatus comprising:
a runtime fingerprint register;
hash circuitry coupled to the register and configured to:
successively generate hash values corresponding to operational states of the apparatus, each successive hash value after a first hash value being generated using a previous one of the hash values and a current operational sate of the apparatus; and
write the successively-generated hash values into the register;
cryptographic circuitry coupled to the register and configured to, in response to an attestation request for verifying a current operational state of the apparatus, retrieve and sign a most recent one of the successive hash values from the register; and
control circuitry configured and arranged with the cryptographic circuitry to:
communicate with a remote circuit for receiving the attestation request;
control the cryptographic circuitry to retrieve and sign the hash value from the register; and
communicate the signed hash value to the remote circuit, therein providing attestation of an operational state of the apparatus.

20. The apparatus of claim 19, wherein:
the hash circuitry is configured to generate the successive hash values in response to a software input corresponding to initiation of a software function; and
the runtime fingerprint register is configured to restrict write access to write commands received directly from the hash circuitry.
